(19) United States
(12) Patent Application Publication
(10) Pub. No.: US 2021/0179879 A1
(43) Pub. Date: Jun. 17, 2021

(54) Metal Hydride Nanoinks

(71) Applicant: National Technology & Engineering Solutions of Sandia, LLC, Albuquerque, NM (US)

(72) Inventors: Timothy J. Boyle, Albuquerque, NM (US); Nelson S. Bell, Albuquerque, NM (US); Adam W. Cook, Albuquerque, NM (US); Jessica Rimsza, Albuquerque, NM (US); Ethan Benjamin Secor, Ames, IA (US)

(21) Appl. No.: 17/114,839

(22) Filed: Dec. 8, 2020

Related U.S. Application Data
(60) Provisional application No. 62/947,227, filed on Dec. 12, 2019.

(51) Int. Cl. C09D 11/52; C09D 11/03; C01B 6/02; B41J 2/175; B41J 2/44

(52) U.S. Cl. CPC C09D 11/52; C09D 11/03; B82Y 30/00; B41J 2/175; B41J 2/442; C01B 6/02

(57) ABSTRACT

Metal hydride nanoparticle inks provide an alternative to traditional metal inks. Metal hydride nanoinks can be printed by aerosol jet printing and cured at elevated temperatures to provide conductive patterns. As an example, printed patterns of titanium hydride nanoink on polyimide and cured by pulsed photonic curing were found to exhibit electrical conductivity, with a sheet resistance on the order of ˜150 Ω/□.

### CROSS-REFERENCE TO RELATED APPLICATION

This application claims the benefit of U.S. Provisional Application No. 62/947,227, filed Dec. 12, 2019, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to printing inks and, in particular, to metal hydride nanoinks.

### BACKGROUND OF THE INVENTION

The field of printed electronics has attracted significant interest across industrial and academic research for its disruptive potential in a wide variety of functions spanning flexible displays, smart packaging, environmental and biomedical sensing, energy conversion and storage, and many more. See K. Fukuda and T. Someya, Adv. Mater. 29, 1602736 (2017); D. Lupo et al., “OE-A Roadmap for Organic and Printed Electronics,” in Applications of Organic and Printed Electronics, Cantatore, E., Ed. Springer: Boston, Mass., 2013; pp 1-26; P. Sarobol et al., Annu. Rev. Mater. Res. 46, 41 (2016); Y. S. Rim et al., Adv. Mater. 28, 4415 (2016); and R. Abbel et al., Adv. Eng. Mater. 20, 1701190 (2018). For each of these applications, the ability to selectively pattern conductive materials is essential. Typically, the conductive inks used for printing fall into several categories, namely metals, metal oxides, conductive polymers, and carbon nanomaterials. See A. Kamyshny and S. Magdassi, Small 10, 3515 (2014). Of these, the most common routes involve metal inks composed of nanoparticles or molecular precursors which are cured after printing to yield conductive traces. See N. C. Raut and K. Al-Shamery, J. Mater. Chem. C 6, 1618 (2018). This imposes the key constraint of oxidation-resistance for materials selection, since many metals are prone to oxidation, particularly in nanoparticle form. As such, printing efforts are largely restricted to air-stable metals, particularly the coinage metals (silver, gold, and more recently copper). See S. Magdassi et al., Materials 3, 4626 (2010). The ability to print additional metals has been restricted to date, limiting the scope of mechanical, chemical, thermal, electrical, and environmental properties attainable. See W. Wu, Nanoscale 9, 7342 (2017).

Therefore, a need remains for alternate materials to print conductive patterns, beyond conventional coinage metals.

### SUMMARY OF THE INVENTION

The present invention is directed to the printing of patterns from a metal hydride (MHₓ) nanoparticle ink (nanoink) which can be subsequently post-processed by high temperature curing. The metal hydride nanoink comprises metal hydride nanoparticles treated with a surfactant and dispersed in a colloidal suspension. The metal hydride nanoparticles are preferably less than one micron and more preferably less than 200 nm in size. A wide variety of metal hydrides can be printed, including transition metal hydrides, lanthanide hydrides, actinide hydrides, alkali metal hydrides, and alkaline-earth metal hydrides. Because the metal hydrides possess inherent reactivity, the printed metal hydrides can be subsequently converted to a variety of materials (metals, oxides, nitrides, sulfides) based on the gas they are exposed to during post-processing. For example, the printing method can comprise aerosol jet printing of the metal hydride nanoink on a substrate followed by pulsed photonic curing to convert the printed metal hydride nanoink to a conductive metal trace.

As an example of the invention, a titanium hydride (TiH₂) nanoink was prepared from TiH₂ powder that was treated with an octylamine surfactant and combined with a dispersant. Subsequent ball milling of the functionalized TiH₂ powder provided a stable TiH₂ nanodispersion suitable for liquid-phase printing methods. Aerosol jet printing of high quality TiH₂ nanoinks was demonstrated on glass and polyimide substrates, with resolutions as fine as 20 μm. Following printing, pulsed photonic curing was used to convert the deposited nanoparticle film into a continuous, conductive network. The photonic curing conditions were shown to influence film microstructure, varying from a porous, high surface area morphology to more dense films for single- and multi-pulse curing. Following photonic curing, printed patterns on polyimide were found to exhibit electrical conductivity, with a sheet resistance on the order of ˜150 Ω/□. This method of using metal hydride nanoinks presents an alternative approach to traditional metal inks, broadening the scope of printable electronic conductors.

### BRIEF DESCRIPTION OF THE DRAWINGS

The detailed description will refer to the following drawings, wherein like elements are referred to by like numbers.

FIG. 1 is a flowchart showing nanoink preparation.

FIGS. 2(a) and 2(b) are scanning electron microscope (SEM) images of TiH₂ particle morphology as-received and following ball-milling, respectively. FIG. 2(c) shows X-ray characterization of TiH₂ following ON-treatment and following ball milling, showing broadening of the diffraction peaks.

FIG. 3 is a schematic illustration of an aerosol jet printer.

FIG. 4(a) is a photograph showing aerosol jet printing of TiH₂ nanoparticle ink on a polyimide substrate. FIGS. 4(b) and 4(c) are optical microscopy images of TiH₂ lines printed on glass and polyimide, respectively. The high-resolution lines on glass, with a line width and pitch of ˜20 and 50 μm, respectively, are printed with different nozzle and print settings.

FIG. 5(a) is a graph of a flow curve showing the printed thickness and nominal deposition rate as a function of aerosol flow rate, showing an approximately linear increase in deposition above a threshold flow rate of ˜6 sccm. FIG. 5(b) is a graph showing the resolution of printed lines over a range of focusing ratios (sheath:aerosol gas flow ratios), for nozzle diameters of 233, 160, and 110 μm. The solid lines show baseline estimates considering only the nozzle diameter and focusing ratio.

FIG. 6 is a schematic illustration of a pulsed photonic curing apparatus.

FIGS. 7(a) and 7(b) are optical and electron microscopy images, respectively, of as-printed TiH₂ films showing a black color and smooth, uniform microstructure (inset image: film photograph, scale bar: 5 mm). FIGS. 7(c) and 7(d) are corresponding microscopy images following pulsed photonic curing, showing a metallic gray film with a porous microstructure.

FIG. 8(a) is a graph of FTIR spectra for a film as-printed and following photonic curing, along with a bare polyimide substrate. FIG. 8(b) is a graph of XRD spectra for a TiH₂ film as-printed and following photonic curing, showing weak peaks associated with the reference. FIG. 8(c) is a graph of sheet resistance of films following photonic curing with varying pulse energies.

### DETAILED DESCRIPTION OF THE INVENTION

The present invention is directed to a novel method for liquid-phase printing of metal-based patterns under ambient conditions. Conductive patterns can be printed from a metal hydride (MHₓ) nanoparticle ink which is subsequently processed to a metal by high temperature curing. The metal hydride nanoinks can be printed on a wide variety of substrates, including glasses, ceramics (e.g., alumina), and polymers (e.g., polyimide). A wide variety of metal hydrides can be printed, including transition metal hydrides, lanthanide hydrides, actinide hydrides, alkali metal hydrides, and alkaline-earth metal hydrides. For example, some commercially available metal hydrides and related borohydrides that can be used include ScH₂, TiH₂, VH₂, ErH₂, LiH, NaH, KH, MgH₂, CaH₂, MBH₄ (M=Li, Na, K, Mg, Ca), and LiAlH₄. Further, the printed traces of reactive nano-MHₓ are internally primed for atomic diffusion, enabling their conversion to materials other than metals (e.g., oxide, nitride, sulfide) by thermal post-processing under different atmospheres (e.g., air, ammonia, hydrogen sulfide).

For example, the method can be used to print electronically conducting titanium-based patterns from titanium hydride nanoparticle inks. While the resistance of titanium metal (Ti⁰) is higher than that of copper or silver metal, titanium offers a suite of advantageous properties for printed electronics over these other metals, including excellent biocompatibility, corrosion resistance, thermal and environmental stability, and adhesion. See K. T. Chiang and L. Yang, Corrosion 66, 095002 (2010); and G. Kotzar et al., Biomaterials 23, 2737 (2002). In particular, Ti⁰ electrodes offer promising benefits for applications in bioelectronics, energy, sensing, and catalysis. See K. T. Chiang and L. Yang, Corrosion 66, 095002 (2010); X. Wang et al., J. Power Sources 230, 81 (2013); and M. Weder et al., Sensors-Basel 15, 1750 (2015). However, rather than starting with highly reactive Ti⁰ nanoparticles or salts, the present invention uses a stable titanium hydride (TiH₂) nanoparticle precursor produced by pre-functionalization of the mesomaterials, followed by ball milling with select surfactants and dispersants. TiH₂ has been employed previously for direct ink writing. See E. Hong et al., Adv. Eng. Mater. 13, 1122 (2011). However, Hong et al. used an ink comprising commercially available TiH₂ powders, with mean particle sizes of 22 and 65 microns, and a copolymer in a graded-volatility solvent, resulting in a highly viscous slurry. Therefore, this ink would be suitable only for fairly low-resolution printing methods. The present invention uses TiH₂ in nanoparticle form to enable high resolution printing and facilitate rapid sintering. The TiH₂ nanoparticle ink can be printed in air using aerosol jet printing, a versatile and high-resolution digital patterning technique. See J. M. Hoey et al., J. Nanotechnol. 2012, 324380 (2012); K. Hong et al., Adv. Mater. 26, 7032 (2014); A. Mette et al., Prog. Photovolt.: Res. Appl. 15, 621 (2007); and M. S. Saleh et al., Sci. Adv. 3, e1601986 (2017). Flash photonic curing using an intense pulsed xenon lamp can provide rapid and localized photothermal heating of the printed patterns, effectively sintering the TiH₂ nanoparticles into a continuous, conductive network on flexible polyimide substrates. See K. A. Schroder et al., “Broadcast Photonic Curing of Metallic Nanoparticle Films,” in NSTI Nanotech, CRC Press: 2006; Vol. 3, pp 198-201.

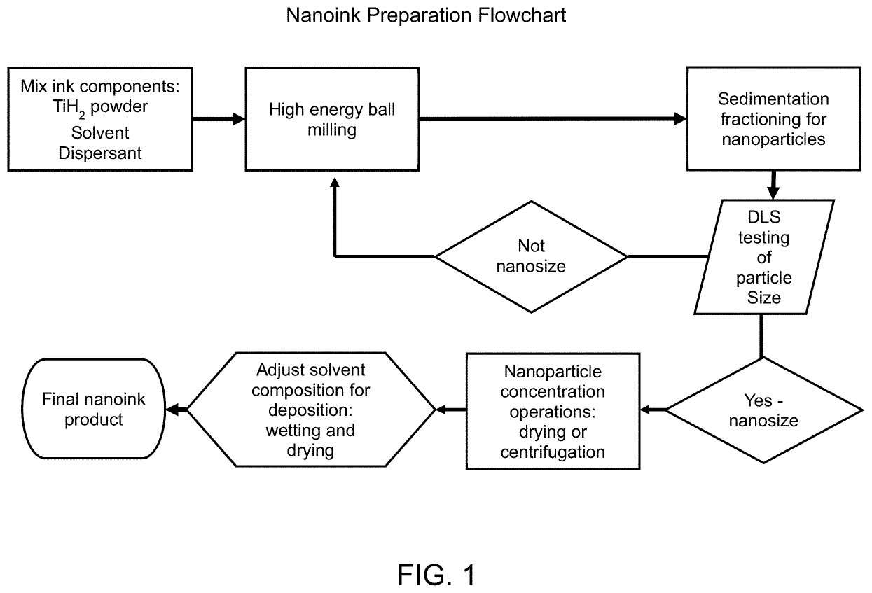

Colloidally stable TiH₂ nanoparticles are needed for printable nanoinks. A flowchart that illustrates the preparation of the nanoinks is shown in FIG. 1. Functionalization of the TiH₂ nanoparticles with surfactant ligands alters the thermodynamic temperature boundary for consolidation via lower surface energy and also inhibits oxidation. The lowered surface energy of the MHₓ/surfactant interfaces enables rapid milling rates yielding stable, nanoparticle suspensions and printable ink formulations. As an example, colloidally stable nanoparticles can be produced through the modification of commercially available TiH₂ microscale powder (typical particle size ˜10 μm) using octylamine (ON) at high temperature (180° C.). However, any functionalization that inhibits particle consolidation can be used, including a wide variety of common amines, such as hexadeclyamine (HDA) and oleylamine (OMA). The decreased surface energy of the TiH₂/surfactant interface facilitates more efficient and effective mechanical milling to produce stable nanoparticle suspensions. Residual ON can be removed by centrifugation and washing with hexanes. To homogenize the powder, the resulting TiH₂/ON material can be ball milled in xylenes with the addition of a dispersant, such as Solsperse™ 9000 (The Lubrizol Corporation). This polymeric surfactant is expected to have adsorption interactions similar to the ON ligands, and therefore displace or intermix with the ON ligands at the surface. However, any surfactant that promotes particle dispersion in the nanoink can be used, including amines, carboxylates, and alcohols. Following each iteration of ball milling, the nanoparticles can be isolated by sedimentation fractioning and tested for particle size by dynamic light scattering (DLS). After a satisfactory nanoparticle size has been achieved, additional nanoparticle concentration and solvent adjustments can be used to prepare the nanoink for printing. The resulting mixture provides a TiH₂ nanoink. The final dark dispersion of TiH₂/ON nanomaterials (nanoparticle size ˜50-200 nm) can be readily dispersed and is stable to aggregation. Over an extended period, some settling of this TiH₂ nanoink can be observed, but the nanomaterials can be redispersed by brief agitation.

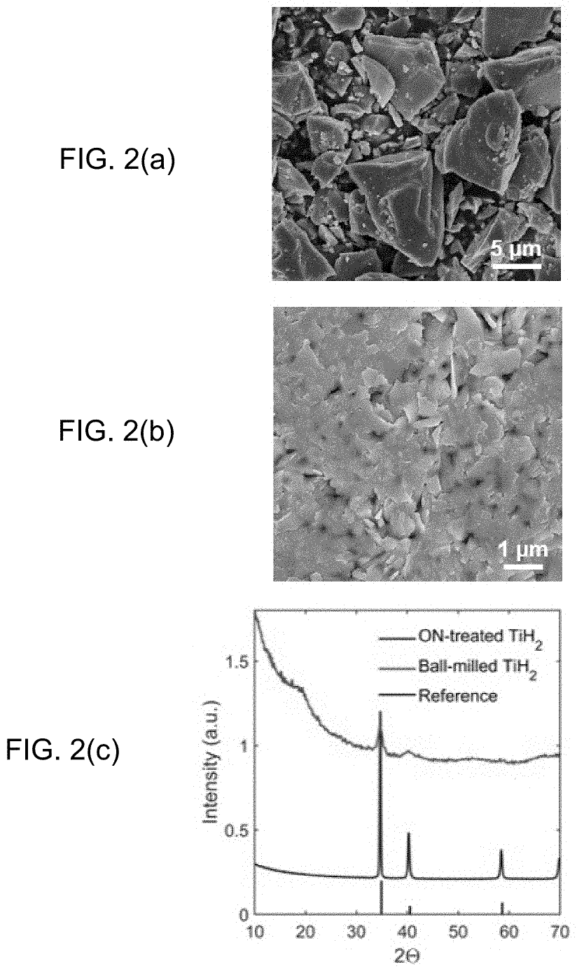

The chemical and structural properties of the TiH₂ nanoparticles are important for subsequent processing and applications. Scanning electron microscopy (SEM) reveals a size reduction from the ˜10 μm as-received particles to sub-micron particles with flake-like morphology following milling, as shown in FIGS. 2(a) and 2(b). This size of the particles was confirmed by DLS, which provided an ensemble average measurement indicating a mean hydrodynamic diameter of 56 nm with a polydispersity index of 0.17. Finally, X-ray diffraction (XRD) measurements following ON-treatment revealed well-defined peaks consistent with ON ligands present on TiH₂ nanomaterials. The peaks were further broadened during the ball milling step due to particle size refinement, as shown in FIG. 2(c), resulting in a mean crystallite size of 157±20 nm based on PXRD fitting.

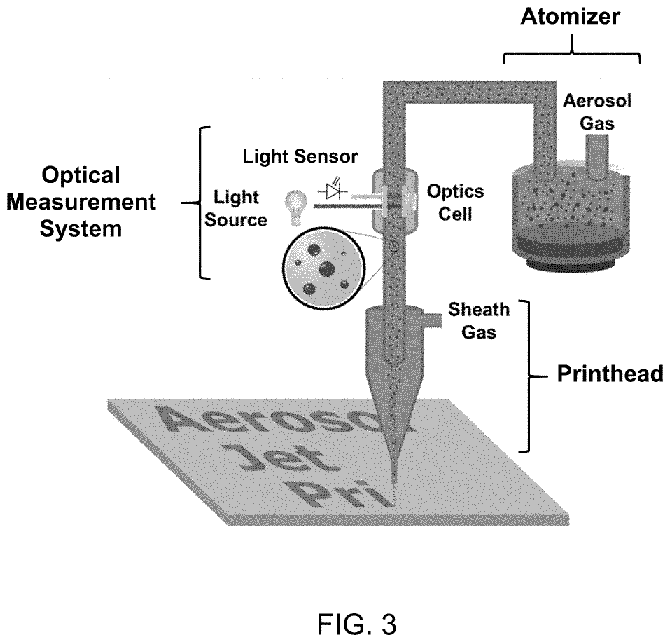

Aerosol jet printing offers a digital, non-contact, high-resolution patterning capability with broad materials compatibility that can print the nanoinks. See E. B. Secor, Flex. Print. Electron. 3, 035002 (2018). FIG. 3 is a schematic illustration of an exemplary aerosol jet printer. During aerosol jet printing, the liquid ink is atomized to produce micron-scale droplets, which are entrained in a gas flow and carried to a printhead. Ultrasonic atomization of the nanoink produces 1-5 μm droplets, which are carried to the printhead on the aerosol stream. Within the printhead, an annular sheath gas surrounds the aerosol stream, collimating it to improve resolution and prevent ink deposition within the printhead. The collimated stream is accelerated through a nozzle to impact upon a substrate. By moving the substrate relative to the printhead with a numerical control motion system, patterns can be defined in software and printed with micron-scale feature sizes. Other printing modalities that can be used to print the nanoinks include ink jet printing, micro-extrusion (direct ink write) printing, electrohydrodynamic printing, flexographic printing, gravure printing, and screen printing.

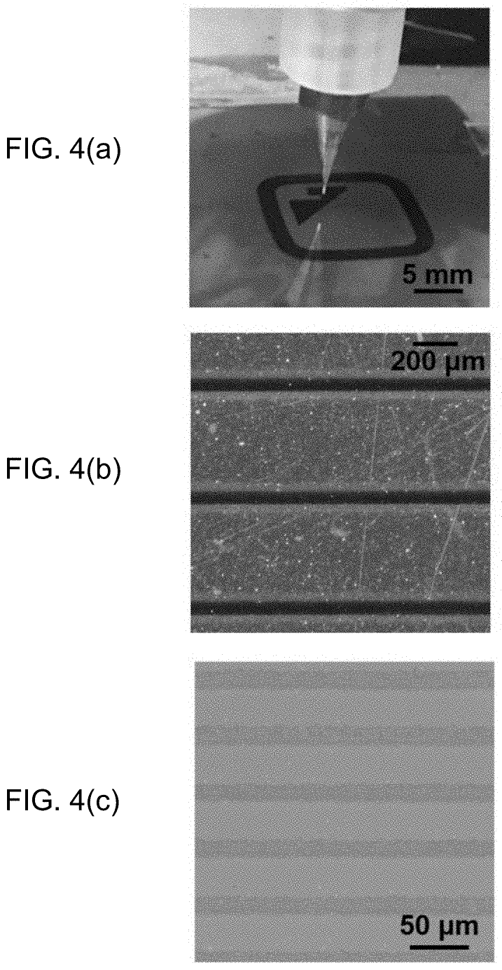

The dispersion stability of MHₓ nanoparticles in nonpolar solvents facilitates ink preparation for aerosol jet printing, which requires small particle size, low viscosity inks, and tailored solvent drying properties. With xylene as the primary ink solvent, tetralin (1,2,3,4-tetrahydronaphthalene) can be added as a low volatility co-solvent to tailor printing characteristics. Therefore, to adapt the stable TiH₂ nanoink to the aerosol jet printing of high resolution patterns, the TiH₂ nanoink was mixed with tetralin in a 4:1 ratio to modify its evaporation kinetics. See E. B. Secor, Flex. Print. Electron. 3, 035002 (2018). FIG. 4(a) is a photograph showing aerosol jet printing of TiH₂ nanoparticle ink on a polyimide substrate. For these experiments, the aerosol flow rate was 5-15 sccm and sheath gas flow rate was 5-80 sccm. The aerosol stream was directed through a deposition nozzle with a narrow orifice of 100-300 μm, yielding a high-resolution pattern (20-100 μm linewidth) on the substrate, as shown in FIGS. 4(b) and 4(c).

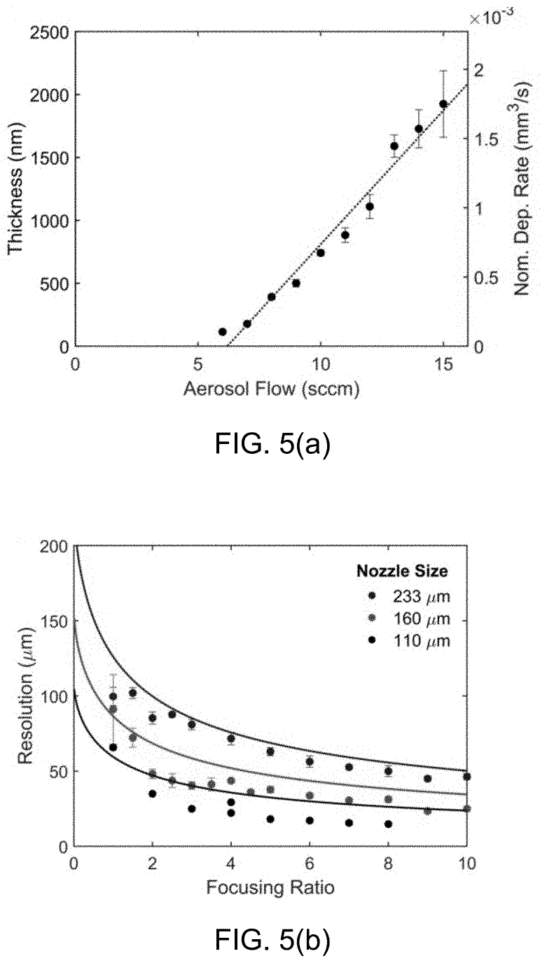

Several calibration tests were performed to quantitatively characterize the printing behavior of the TiH₂ nanoink. First, the deposition rate was determined to elucidate the thickness of printed films at varied aerosol flow rates. FIG. 5(a) is a graph of a flow curve showing the printed thickness and nominal deposition rate as a function of aerosol flow rate, showing a threshold flow rate of ˜6 sccm, below which little material deposition was observed. A fairly linear increase in film thickness or deposition rate with increasing flow rate (0.70±0.04 mm³/hr per sccm) was observed above this threshold, establishing a suitable range for printing. The sheath gas flow rate imposes a secondary effect on the deposition rate due to droplet impaction processes. To test the resolution capabilities for this ink, individual lines were printed and characterized. In this setup, the focusing ratio, defined as the sheath:aerosol gas flow ratio, is expected to modulate the collimation of the aerosol stream, and thus the resolution. See A. Mahajan et al., ACS Appl. Mater. Inter. 5, 4856 (2013). The print nozzle diameter is another key factor in determining the print resolution. FIG. 5(b) is a graph showing the line resolution printed with a range of focusing ratios, using three different nozzle sizes (233, 160, and 110 μm). The solid lines show baseline, ink-agnostic estimates of resolution, which are largely consistent with the measured values. See E. B. Secor, Flex. Print. Electron. 3, 035002 (2018). Using the 110 μm nozzle, a resolution as fine as 20 μm was achieved on both glass and polyimide substrates. In addition to deposition rate and resolution, print consistency is a key challenge for reliable aerosol jet printing. In this case, a ˜50% decrease in the film was observed during continuous printing (˜5 h) to assess the drift and stability of the process, which was attributed to composition drift of the ink within the cartridge. Despite this drift, the long 5 h time frame of continuous printing demonstrates the efficacy of aerosol jet printing and does not necessarily represent a limitation of the ink. See M. Smith et al., Flex. Print. Electron. 2, 015004 (2017). Addition of an optical measurement system to enable in-line process monitoring and control of the aerosol stream, as shown in FIG. 2, can help to prevent process drift and improve print consistency. See U.S. application Ser. No. 16/935,823 to Secor et al., filed Jul. 22, 2020.

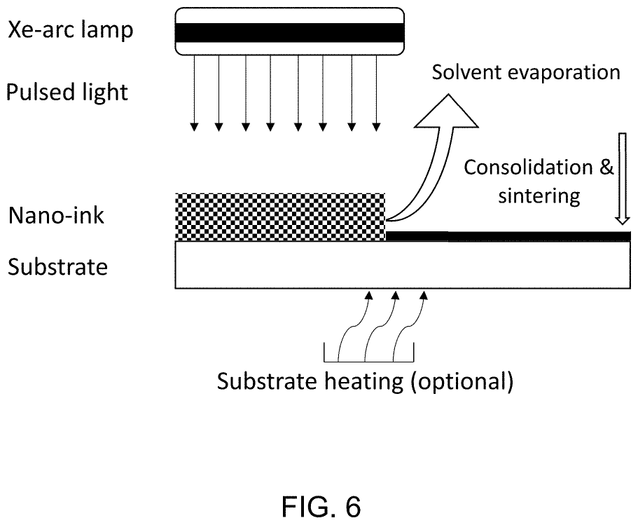

A key challenge for metal-based inks is the identification of a suitable post-processing treatment that results in an electrically continuous, functional network from individual printed particles. This is particularly challenging for transition metal hydride inks on polymer substrates, as the conversion of TiH₂ to Ti metal (Ti⁰) requires high temperature (450-600 ° C.) dehydriding under vacuum followed by high temperature sintering, conditions unsuitable for flexible plastic substrates. To overcome these challenges, pulsed photonic curing can be used, as illustrated in FIG. 6. This method uses a broadband pulsed light source (commonly a Xe-arc flash lamp) to produce a high intensity (˜1-10 kW/cm²), short (˜1 ms) light pulse. See K. A. Schroder et al., “Broadcast Photonic Curing of Metallic Nanoparticle Films,” in NSTI Nanotech, CRC Press: 2006; Vol. 3, pp 198-201; D. Angmo et al., Adv. Energy Mater. 3, 172 (2013); and J. Perelaer et al., Adv. Mater. 24, 2620 (2012). This has been previously applied to a diverse range of nanomaterials, including copper, graphene, silicon, and semiconducting and piezoelectric metal oxides. See E. Drahi et al., Thin Solid Films 574, 169 (2015); B. L. Greenberg et al., Nano Left. 17, 4634 (2017); H. S. Lim et al., J. Mater. Chem. C 5, 7142 (2017); J. Ouyang et al., J. Am. Ceram. Soc. 99, 2569 (2016); M. S. Rager et al., ACS Appl. Mater. Inter. 8, 2441 (2016); and E. B. Secor et al., Adv. Mater. 27, 6683 (2015). The photonic curing light pulse is expected to be selectively absorbed in the TiH₂ film, leading to rapid heating to high temperatures that will evaporate the solvent and sinter the nanoparticle traces while limiting thermal damage to the substrate. Other thermal treatment methods that can be used include laser sintering and rapid thermal processing.

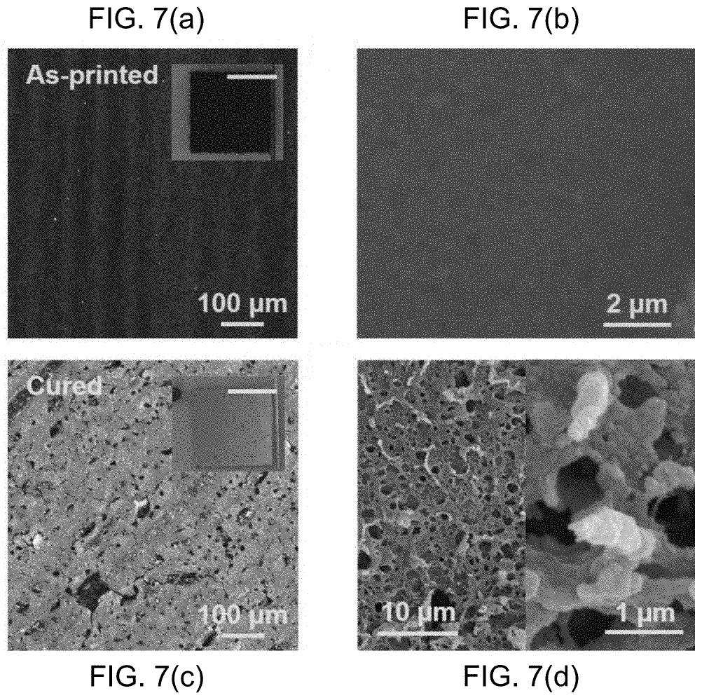

Photonic curing for TiH₂ films was investigated using a PulseForge® (NovaCentrix) photonic curing instrument with 1 ms light pulses of 1-10 J/cm². Prior to photonic curing, printed TiH₂ films have a black appearance with a uniform microstructure of TiH₂ nanoparticles and polymer binder, as shown in FIGS. 7(a) and 7(b). Upon exposure to the high energy light pulse, a visible transformation was observed, resulting in a metallic gray film with clear microstructural evolution, as shown in FIGS. 7(c) and 7(d). The SEM images reveal a porous, high surface area microstructure, with evidence of sintered primary particles. This is likely a result of the rapid nature of the photonic curing process and the release of gaseous species upon decomposition or conversion of the dispersant, ligands, and TiH₂. While not suitable for dense, highly conductive lines, anticipated applications of this material are distinct from traditional conductors, such as silver, and for a number of applications (i.e., energy, catalysis, sensing, etc.) this high surface area morphology can be particularly advantageous.

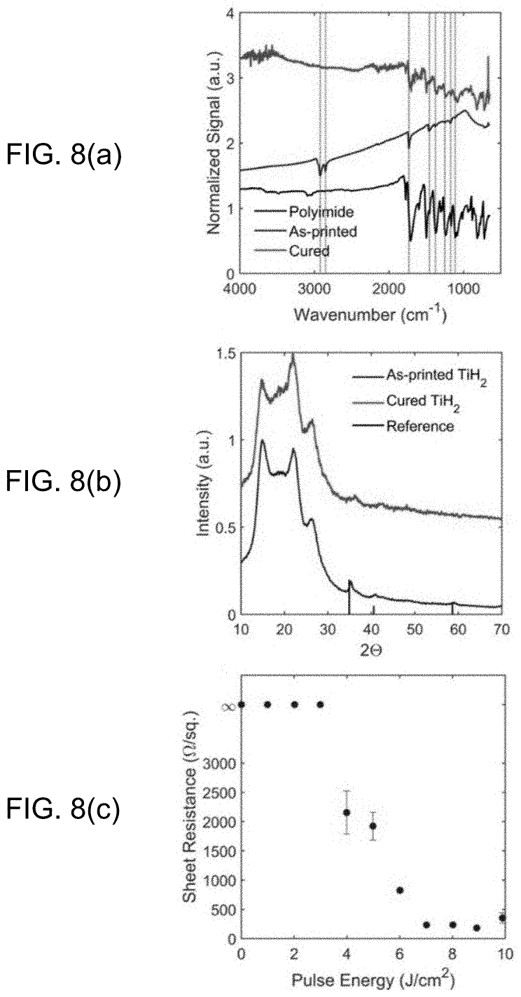

Chemical changes occurring during photonic curing are apparent by more in depth characterization. Fourier transfer infrared spectroscopy (FTIR) of samples prior to photonic curing show clear peaks associated with the dispersant, particularly in the 2800-3000 cm⁻¹ range, as shown in FIG. 8(a). Following photonic curing, no evidence of these peaks was apparent, though there were weak peaks corresponding to the polyimide substrate. Prior to curing, XRD indicated the presence of peaks associated with TiH₂. These peaks were present but harder to distinguish, following the photonic curing process, as shown in FIG. 8(b), suggesting that at least some sintered TiH₂ remains. For a more systematic test, pulse energies of 1-10 J/cm² were applied in 1 J/cm² increments, leading to expected heating to peak temperatures up to ˜3000° C. See M. J. Guillot et al., Simulating the Thermal Response of Thin Films During Photonic Curing. In ASME International Mechanical Engineering Congress and Exposition, ASME: Houston, Tex., USA, 2012; Vol. 7, pp 19-27. As shown in FIG. 8(c), high energy photonic curing resulted in electrically conductive films, with a typical sheet resistance of ˜200 Ω/□. This method therefore allows curing on polyimide substrates, which is not possible using conventional thermal annealing. Indeed, thermal curing of patterns on silicon wafers required a temperature as high as 800° C. under nitrogen to yield comparable electrical properties. Moreover, the efficacy of photonic curing appears to be independent of the process environment, with similar results observed following curing under H₂/N₂, light vacuum, and air.

While single-pulse photonic curing is effective, it can lead to a porous microstructure; whereas, multiple pulses can provide an effective means to control the final morphology. In this case, the initial light pulse likely decomposes the organic constituents, leading to gas evolution and pore formation, while the second pulse reheats the metallic material to close pores. Overall this multi-pulse process led to improved electrical performance, with a sheet resistance as low as ˜150 Ω/□, a more lustrous visual appearance, and a denser film morphology. In this case, it appears that the photonic curing process leads to melting and solidification of the trace, with material migration possible due to capillary effects, particularly in thin films. This constrains the film geometries suitable to photonic curing, in that thin films or narrow lines can lose electrical continuity if cured with excessive intensity.

In comparison to traditional printed metals, Ti⁰ exhibits increased stability to environmental stressors, which makes it useful for electrochemical, biological, and high temperature applications. Therefore, the conductive films were also tested for resilience under a variety of stressors to evaluate their suitability for these applications. To test the thermal stability of patterns, the resistance was measured following heating to temperatures as high as 400° C. in air. While an increase in resistance was observed following heating at higher temperatures, the films showed reasonable stability up to 300° C. Given the high surface area and thin geometry of the films, some oxidation at the higher temperatures is expected to have occurred. To test the flexibility of patterns, the resistance was measured following bending to two different radii of curvature, 13.7 and 6.4 mm. An increase in resistance was observed at high cycle numbers (>100 cycles), but the demonstrated tolerance to bending remains suitable for less demanding applications. This limited mechanical durability is likely the result of damage at the film-substrate interface.

The present invention has been described as metal hydride nanoinks. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A metal hydride nanoink, comprising metal hydride nanoparticles and a surfactant colloidally suspended in a solvent.

2. The metal hydride nanoink of claim 1, wherein the metal hydride nanoparticles are less than 1 μm in size.

3. The metal hydride nanoink of claim 2, wherein the metal hydride nanoparticles are less than 200 nm in size.

4. The metal hydride nanoink of claim 1, wherein the metal hydride comprises a lanthanide hydride, actinide hydride, alkali metal hydride, or alkaline-earth metal hydride.

5. The metal hydride nanoink of claim 1, wherein the metal hydride comprises a transition metal hydride.

6. The metal hydride nanoink of claim 5, wherein the transition metal hydride comprises titanium hydride.

7. The metal hydride nanoink of claim 1, wherein the surfactant comprises an amine.

8. The metal hydride nanoink of claim 1, further comprising a dispersant that promotes nanoparticle dispersion in the nanoink.

9. The metal hydride nanoink of claim 1, further comprising a low volatility co-solvent to tailor printing characteristics of the nanoink.

10. The metal hydride nanoink of claim 9, wherein the low-volatility co-solvent comprises tetralin.

11. A method for printing a metal hydride pattern, comprising:
printing a metal hydride nanoink on a substrate, wherein the metal hydride nanoink comprises metal hydride nanoparticles and a surfactant colloidally suspended in a solvent, and
post-processing the printed metal hydride nanoink at an elevated temperature.

12. The method of claim 11, wherein the metal hydride nanoparticles are less than 1 μm in size.

13. The method of claim 12, wherein the metal hydride nanoparticles are less than 200 nm in size.

14. The method of claim 11, wherein the metal hydride comprises a transition metal hydride, lanthanide hydride, actinide hydride, alkali metal hydride, or alkaline-earth metal hydride.

15. The method of claim 14, wherein the transition metal hydride comprises titanium hydride.

16. The method of claim 11, wherein the metal hydride nanoink further comprises a dispersant that promotes nanoparticle dispersion in the nanoink.

17. The method of claim 11, wherein the metal hydride nanoink further comprises a low volatility co-solvent to tailor printing characteristics of the nanoink.

18. The method of claim 11, wherein the printing comprises aerosol jet printing.

19. The method of claim 11, wherein the printing comprises ink jet printing, micro-extrusion printing, electrohydrodynamic printing, flexographic printing, gravure printing, or screen printing.

20. The method of claim 11, wherein the post-processing comprises curing the printed metal hydride nanoink at a sufficient elevated temperature to convert the metal hydride to a metal.

21. The method of claim 20, wherein the curing comprises pulsed photonic curing.

22. The method of claim 20, wherein the curing comprises laser sintering or rapid thermal processing.

23. The method of claim 20, wherein the printed metal hydride nanoink is cured at an elevated temperature of greater than 450° C.

24. The method of claim 11, wherein the post-processing comprises converting the printed metal hydride nanoink to a metal oxide, metal nitride, or metal sulfide by exposing the printed metal hydride nanoink to a reactive gas.
